(19) United States
(12) Patent Application Publication
(10) Pub. No.: US 2006/0037036 A1
(43) Pub. Date: Feb. 16, 2006

(54) Remote control method of home network and system thereof

(76) Inventors: Ku-Bong Min, Seoul (KR); Sung-Joon Ahn, Yongin, Gyeonggi-Do (KR); Min-Seok Kang, Seoul (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(21) Appl. No.: 10/520,399

(22) PCT Filed: Jun. 30, 2003
(86) PCT No.: PCT/KR03/01289

§ 371 Date: Jan. 5, 2005

(30) Foreign Application Priority Data
Jul. 10, 2002 (KR) 10-2002-0040079

(51) Int. Cl. H04N 7/16

(52) U.S. Cl. 725/1

(57) ABSTRACT

A remote control method of a home network and system thereof are disclosed to remotely control devices connected to a home network system. A control point of a home network is set at a home agent in the home network system and at a remote terminal respectively, and then the control point set at the home agent and the control point set at the remote terminal are connected through a specific channel, thereby controlling the device(s) connected to the home network system.

### TECHNICAL FIELD

The present invention relates to a home network, and in particular to a remote control method of a home network and its system.

### BACKGROUND ART

Recently, with the wide spread of high speed Internet and digitalization of electric home appliances, there has been attempted to construct a household PC (personal computer), a network gateway unit, an audio/video apparatus, electronic appliances and a controller as one home network.

A UPnP (Universal Plug and Play), defined by a protocol of a standard network architecture, is one of the influential standard technologies in the home network field which plural companies of each country are making by organizing a UPnP forum. A UPnP-based network system includes plural UPnP devices providing a service and CPs (Control Points) controlling the plural UPnP devices.

The CP, an entity for controlling various devices such as UPnP devices, discovers various UPnP devices according to a key input of a user, describes functions of the discovered UPnP devices, and controls the UPnP devices.

The UPnP device is an apparatus such as a PC (personal computer), network equipment, a peripheral apparatus such as a printer, an audio/video apparatus and electronic appliances, which are connected to the home network. The UPnP device informs a CP of an event and can control a device and detect a state of the device by using a web page by providing a presentation page to the CP. Hereinafter, a UPnP protocol stack based on a UPnP device architecture version 1.0 will now be described with reference to FIG. 1.

FIG. 1 is a view showing a UPnP protocol stack.

As shown in FIG. 1, a UPnP protocol stack based on a conventional UPnP device architecture version 1.0 includes a network layer 114 including an IP (Internet Protocol); a transport layer 113 including a UDP (User Datagram Protocol) and a TCP (Transmission Control protocol); a presentation/session layer 112 including protocols of HTTP, XML (Extensible Markup Language) (not shown), SOAP (Simple Object Access Protocol) and SSDP (Simple Service Discovery Protocol), and an architecture such as a GENA (Generic Event Notification Architecture); and an application layer 111 including related information such as a UPnP device, a forum and a vender, etc.

In a UPnP network system to which the UPnP protocols are applied, a communication method between the CP and devices (UPnP devices) includes an addressing step that IP addresses are allocated to the devices; a discovery step that the CP discovers an existence of the devices; a function description step that the CP describes information of the devices and a service supported by the device; a control step that the CP calls the service of the device; an eventing step that the device informs the CP of its state change; and a presentation step that the device displays its state and control information. These will now be described with reference to FIG. 2, which is an operation state view showing a discovery process of a UPnP network.

FIG. 2 is a view showing a state that a UPnP device 221 multicasts an advertising message to UPnP CPs 211 and 212 and a state that a UPnP device 222 responds when CP 213 transmits a search message to the UPnP devices 221 and 222.

In a first method, the CP discovers a UPnP device by using a SSDP (Simple Service Discovery Protocol). At this time, when the discovered device 221 is connected to a UPnP network, the device 221 multicasts an advertising message to the CP, whereby the CPs 211 and 212 confirms an existence of the UPnP device(s) on the basis of the multicast message from the device 221.

In a second method, when the CP 213 is connected to a UPnP network, the CP 213 multicasts a search message to a device. The device 222 receiving the search message transmits its information to the CP 213 through a unicast. Also, a SOAP (Simple Object Access Protocol) is used to control the devices connected to the UPnP network, and the GENA is used to receive a state event of the devices.

In the conventional UPnP device architecture version 1.0, it is assumed that every element of a home network is located at a local network, so a connection service at a remote area is not considered. In case that the CP exists at an external network and tries to access the home network, the CP should be able to use a UPnP protocol mechanism even at the external network. If a terminal connected at a remote area is a wireless terminal, a limited calculation capability, a memory unit, a display capability and a network environment of the wireless terminal should be considered. That is, in a conventional UPnP standard art, even though an ALIVE, M-SEARCH message of a UPnP search and a BYE-BYE message of an eventing are based on the IP multicast, the multicast is impossible if the CP exists at a remote area. Accordingly, in the case that the CP is not in a local network, an Internet network should support the IP multicast so that the device search can be normally performed.

However, the conventional IP network cannot discover the UPnP device(s) of a home network through a UPnP search at a remote area because the IP network does not support a multicast effectively. Also, in the conventional UPnP device architecture version 1.0, a TTL (Time To Live) value of an IP header of a packet to be multicast is limited to four in order to prevent network confusion caused by a multicast packet. In addition, frequent event message transmission is incongruent in a radio environment because the conventional UPnP architecture version 1.0 has no special consideration for a radio terminal environment.

Accordingly, a presentation page used in a wire environment needs to be reconstructed in consideration of the radio environment because of the limitation of a display unit. Since stacks of TCP/IP and HTTP may not be used depending on a kind of a terminal in case that a remote access CP is loaded in a wireless terminal, a method for coping with this situation is needed. In conclusion, in a UPnP home network connection at a remote area, a proxy acting for every function of the CP in the home network and an appropriate message conversion are needed in order to solve the described problems.

### DISCLOSURE OF THE INVENTION

Therefore, it is an object of the present invention to provide a remote control method of a home network and its system capable of controlling devices connected with a home network system at a remote area.

It is another object of the present invention to provide a remote control method of a home network and its system capable of controlling devices connected to a home network system at a remote area by respectively setting CP provided to the home network system at a home agent in the home network system and at a remote control point of the remote terminal.

It is another object of the present invention to provide a remote control method of a home network and its system capable of easily and remotely controlling a device connected to a UPnP (Universal Plug and Play)—based home network, by respectively setting a UPnP CP provided to the UPnP—based home network system at a home agent in the UPnP hope network system and at a remote CP of a remote terminal, and connecting the UPnP CP set at the home agent and the UPnP CP set at the remote control point through a certain channel.

To achieve these objects, there is provided a remote control method of a home network comprising the steps of respectively setting a CP controlling devices connected to a home network system at a home agent in the home network system and at a remote CP of a remote terminal; and connecting the CP set at the home agent and the CP set at the remote CP through a specific channel.

To achieve these objects, there is provided a remote control system of a home network including a home network; a home agent communicating with devices connected to the home network and having a function of a CP used at the home network; and a remote CP set at a remote terminal and having a function of the CP. Herein, the CP of the home agent and the CP of the remote CP are connected through a specific channel.

To achieve these objects, there is provided a remote control system of a home network including a UPnP (Universal Plug and Play)—based home network; a home agent communicating with UPnP devices in the home network and having a function of a UPnP CP used at the UPnP-based home network; a remote CP set at a remote terminal and having a function of the UPnP CP; and a user interface unit installed at the remote terminal and providing an interface to a user. Herein, the UPnP CP of the home agent and the UPnP CP of the remote CP are connected through a specific channel.

### BRIEF DESCRIPTION OF THE DRAWINGS

FIG. 1 is a view showing a UPnP protocol stack.

FIG. 2 is a view showing a state that a UPnP device multicasts an advertising message to a UPnP CP and a state that the UPnP device responds when CP transmits a search message to the UPnP device.

FIG. 3 is a block chart showing a structure of a remote control system of a UPnP-based home network according to a first embodiment of the present invention.

FIG. 4 is a view showing a structure of a home network remote control system to which a UPnP CP stack having stacks of TCP/IP and HTTP is applied according to a second embodiment of the present invention.

FIG. 5 is a signal flow chart of the home network remote control system to which the same UPnP CP stack as of the FIG. 4 is applied.

FIG. 6 is a view showing a home network remote control system to which a UPnP CP stack having WAP (Wireless Application Protocol) stack instead of stacks of TCP/IP and HTTP is applied according to a third embodiment of the present invention.

FIG. 7 is a signal flow chart of a home network remote control system to which the same UPnP CP stack as of FIG. 6 is applied.

FIG. 8 is an exemplary view showing case that a function of a home agent and a remote CP is distributed so that the home agent performs most of UPnP CP functions and shows only an interface to the remote CP.

### MODES FOR CARRYING OUT THE PREFERRED EMBODIMENTS

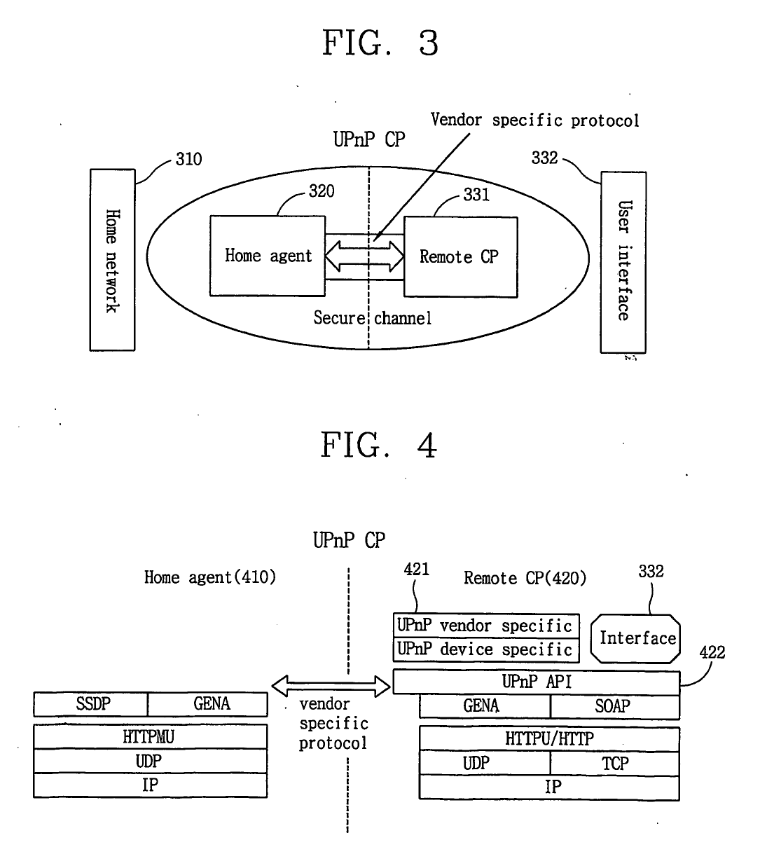

A remote control method of a home network and its system capable of easily and remotely controlling a device connected to a UPnP-based home network at a remote area by respectively setting a UPnP CP at a home agent and at a remote CP of a remote terminal, and connecting the UPnP CP set at the home agent and the UPnP CP set at the remote CP through a specific channel, will now be described in detail with reference to FIGS. 3 to 8.

FIG. 3 is a block chart showing a structure of a remote control system of the UPnP-based home network according to a first embodiment of the present invention. Herein, a function of a UPnP CP used at the UPnP-based home network is distributed to a home agent (HA) and to a remote CP 331.

For example, a local CP, a UPnP CP used at the UPnP-based home network monitors whether a remote CP is enabled, and determines whether the local CP transfers its authority for controlling a UPnP device to the remote CP according to the monitoring result. That is, the local CP receives state information of the remote CP, and determines a range of the authority transfer on the basis of the received state information. Herein, the state information means information about a processing capability of a remote terminal.

The remote CP checks whether it is possible to be connected with the local home network, then, is coupled with the home network on the basis of the check result and transmits its state information to the local home network when the remote CP is connected to the home network. That is, the remote CP controls the device through the local CP.

As shown in FIG. 3, a remote control system of the UPnP-based home network according to the present invention includes a UPnP-based home network 310; a home agent 320 including a function of a UPnP CP (local CP) used at the home network 310, and being a UPnP protocol process unit communicating with the UPnP devices in the home network 310; a remote CP 331 including a function of the UPnP CP, and set at a remote terminal (e.g., mobile terminal equipment); and a user interface unit 332 set at the remote terminal, and providing an interface to a user. Herein, the remote terminal means a device (e.g., a wireless terminal or a mobile terminal positioned) at a remote area, which is not connected with a local network to which UPnP devices are connected.

Hereinafter, an operation of a remote control system of a UPnP-based home network according to the present invention will now be described in detail.

First, preferably, in a UPnP protocol process at a home agent 320, a device search and an eventing are processed in a local home network by using an IP multicast. Also, user interface output should be performed at a remote terminal.

Then, a function of a UPnP CP is distributed to the home agent 320 (HA) and the remote CP. For instance, a function of the UPnP CP is distributed to the home agent 320 in the home network and the outside remote CP 331, and then, the UPnP CP distributed to the HA 320 and the UPnP CP distributed to the remote CP 331 are made a one to one connection through a specific channel (e.g., a secure channel). Herein, a UPnP event message is transmitted through an IP unicast by using a GENA.

When a UPnP message is transmitted through the IP unicast, the event message is not directly transmitted to the remote CP, but the HA 320 receives the message, moderates the received event message. The HA 320 may transmits the moderated event message to the remote CP 331 or may be constructed so that the remote CP 331 can obtain the event message from the HA 320 by polling. This Is useful when an event message is generated frequently.

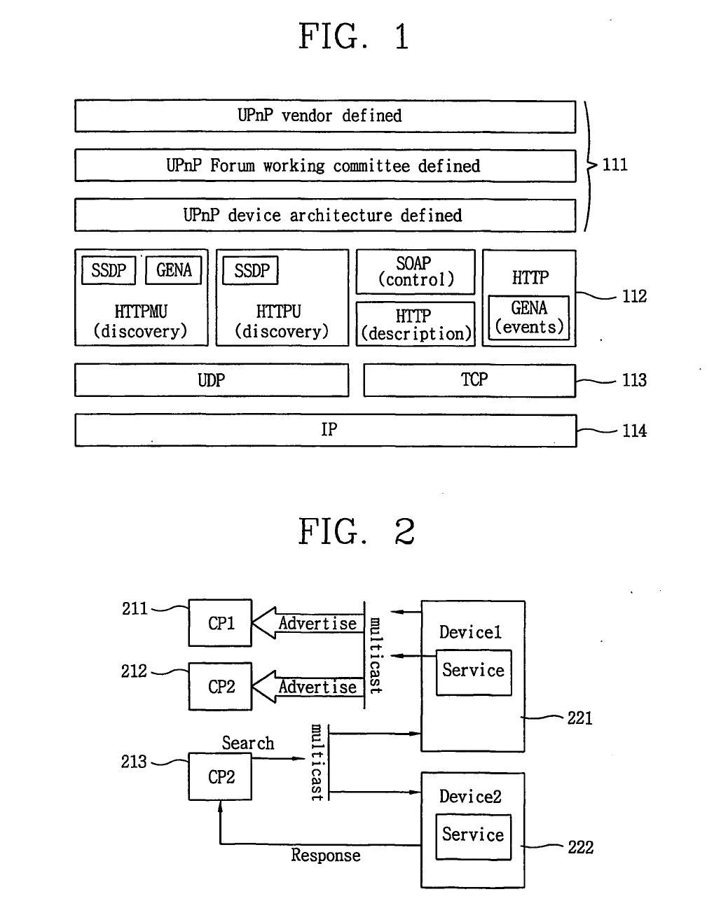

As shown in FIG. 1 of the conventional art, a UPnP protocol stack includes basic internet protocols 112 to 114, a section defined at a UPnP device architecture, and a section 111 defined by being specialized according to a kind of each equipment and a vendor. Accordingly, the HA 320 and the remote CP 331 can receive a basic service of UPnP devices through a UPnP API defined at each device architecture.

However, the UPnP service (e.g., UPnP API) defined in the UPnP device architecture is not sufficient to use functions specialized by equipment and manufacturers. Thus, in constructing the UPnP CP, each UPnP device is specialized, or specific functions of a UPnP device is separately constructed as a component, thereby being installed for use whenever necessary. Accordingly, an optimized UPnP control point function can be implemented, and a minimized storage space of a remote terminal can be used as well. For instance, as shown in FIG. 4, a function of the home agent and the remote terminal can be distributed in case that the remote terminal has both stacks of TCP/IP and HTTP.

FIG. 4 is a view showing a structure of a remote control system of the home network to which a UPnP CP stack having stacks of TCP/IP and HTTP is applied according to a second embodiment of the present invention.

As shown in FIG. 4, the home agent 410 performs a function using an IP multicast, which is a part of functions of a SSDP and a GENA. The remote CP 420 performs functions of a series of a SOAP, a GENA and a user interface including functions of a device/vendor specific component 421 and a UPnP API (Application Program Interface) 422.

In addition, the function of which the home agent 410 takes charge is transferred to the remote CP 420 by a defined vendor specific protocol. Accordingly, the remote CP 420 performs device search and eventing functions, which are a part of functions of the remote CP, through the HA 410, and performs other functions by directly accessing the device. That is, if a distributing environment technology is used, the UPnP API of the remote CP 420 processes a function performed at the home agent as if the function is processed at a local.

Accordingly, an application program made out by using the UPnP API operates without regard to a distributing process of UPnP stacks 112 to 114 of FIG. 1 implemented in order to provide the API. That is, the remote terminal can control the UPnP devices with the same function as that of the UPnP CP in the home network through a UPnP CP set at the remote CP at a remote area.

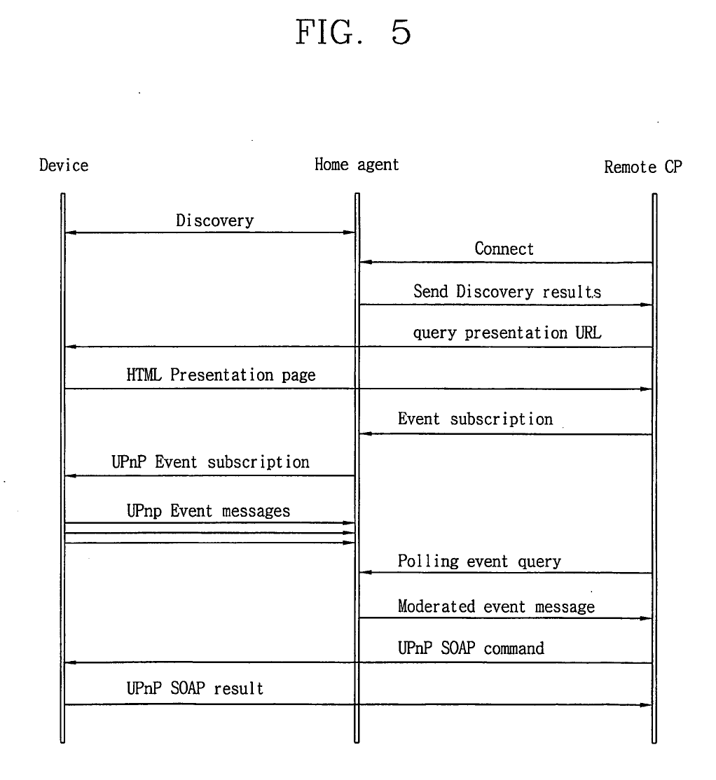

Hereinafter, an operation of a home network remote control system to which a UPnP control point stack including both stacks of TCP/IP and HTTP is applied according to the second embodiment of the present invention, will now be described with reference to FIG. 5.

FIG. 5 is a signal flow chart of a remote control system of a home network to which the same UPnP CP stack as that of FIG. 4 is applied.

First, the home agent 410 discovers UPnP devices in the home network through the UPnP device and the UPnP search process, and stores information related to the discovered devices.

When the remote CP 420 is connected to the home agent 410, the home agent 410 transmits the stored information to the remote CP 420.

The remote CP 420 directly requests a pertinent UPnP device for a presentation page of a device to be controlled based on a device list of the stored information. At this time, the pertinent UPnP device transmits a HTLM page corresponding to the request to the remote CP 420.

Then, the remote CP 420 transmits a UPnP event subscription request in order to receive an event message of the UPnP device. At this time, the home agent 410 receives the event message transmitted from the pertinent UPnP device by transmitting the UPnP event subscription request to the pertinent UPnP device. In addition, the home agent summarizes the event message.

The remote CP 420 receives the summarized event message from the HA 410 by performing periodical polling. According to this, when the remote CP 420 tries to control the pertinent UPnP device, the remote CP 420 composes the SOAP message, directly requests the pertinent UPnP device and receives a response message.

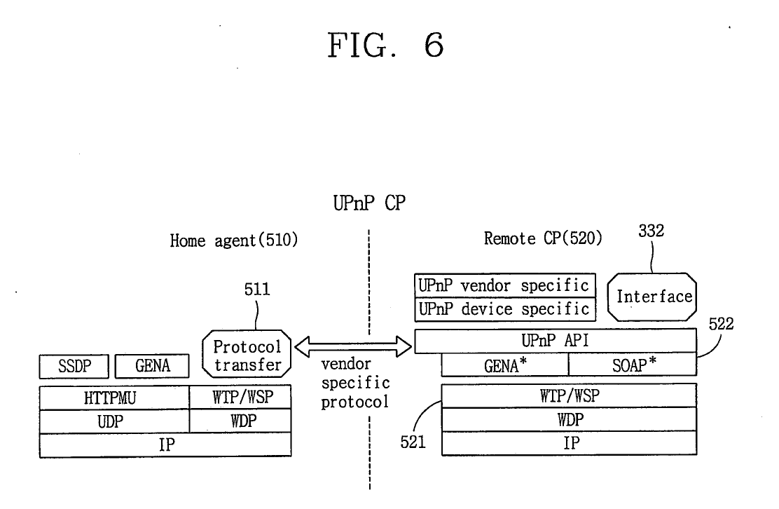

FIG. 6 is a view showing a remote control system of a home network to which a UPnP control point stack having a WAP (Wireless Application Protocol) stack 521 instead of stacks of TCP/IP and HTTP is applied according to a third embodiment of the present invention.

First, the home agent 510 performs a function using an IP multicast, which is a part of functions of the SSDP and the GENA, and a WAP gateway function 511 converting the SOAP* and a GENA* messages defined in a WML (Wireless Markup Language) into the SOAP and the GENA messages in an existing XML (Extensible Markup Language), and carrying the message on a HTTP (Hypertext Transfer Protocol). At this time, because the remote terminal supports the same UPnP API as in the case that the remote terminal has stacks of TCP/IP and HTTP, the remote terminal can share an application between itself and a WAP phone. Herein, the SOAP* and the GENA* 522 are the SOAP and the GENA included In the WAP stack.

Also, the WAP gateway function can exist in an external network. That is, the WAP gateway function can exist between the home agent 510 and the remote CP 520 by separating the WAP gateway from the home agent 510 to the outside.

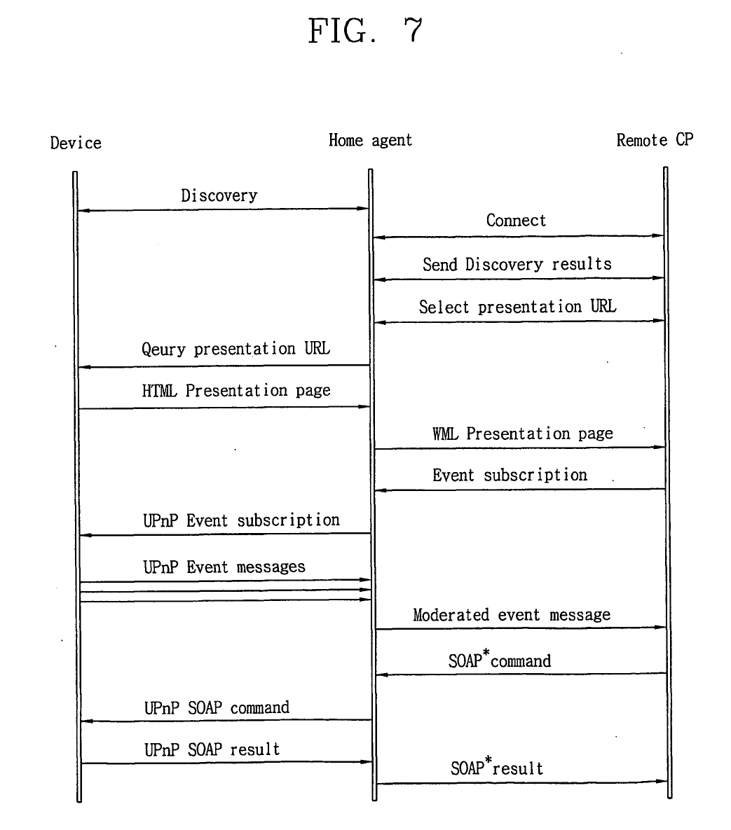

Hereinafter, an operation of a remote control system of a home network to which a UPnP CP stack including a WAP (Wireless Application Protocol) stack 421 instead of stacks of TCP/IP and HTTP is applied according to the third embodiment of the present invention will now be described with reference to FIG. 7.

FIG. 7 is a signal flow chart of a home network remote control system to which the same UPnP CP stack as of FIG. 6 is applied.

First, the home agent 510 discovers UPnP devices in the home network through a UPnP device and a UPnP search process, and stores information related to the discovered UPnP device.

Then, when the remote CP 520 is connected to the home agent 510, the home agent 510 transmits the stored information to the remote CP 520.

The remote CP 520 requests the home agent 510 for a presentation page of a device to be controlled based on a device list of the received information. At this time, the home agent 510 requests the device to be controlled by the remote CP 520 for a presentation page.

The UPnP device to be controlled by the remote CP 520 transmits a HTML page to the home agent 510 according to the request of the home agent 510.

The home agent 510 receives the HTML page from the UPnP device, converts the received HTML page into a WML document, and transmits the converted WML document to the remote CP 520.

Then, the remote CP 520 transmits an event subscription request signal to the home agent 510 in order to receive the event message of the UPnP device.

The home agent 510 requests a pertinent UPnP device for a UPnP event subscription. At this time, the home agent 510 receives the event message transmitted from the UPnP device according to the UPnP event subscription request.

Then, the home agent 510 summarizes the received event message, and transmits the summarized event message to the remote CP 520 with a predetermined time interval. At this time, the remote CP 520 composes a WML version of the SOAP* message and transmits the composed message to the home agent in order to control the UPnP device.

The home agent 510 converts the SOAP* message defined in the WML version into the SOAP message in XML (Extensible Markup Language), and transmits the converted SOAP message to the UPnP device. According to this, the UPnP device transmits a response message to the home agent 510. The home agent 510 converts the response message transmitted from the UPnP device into a WML format, and transmits the converted response message to the remote CP 520.

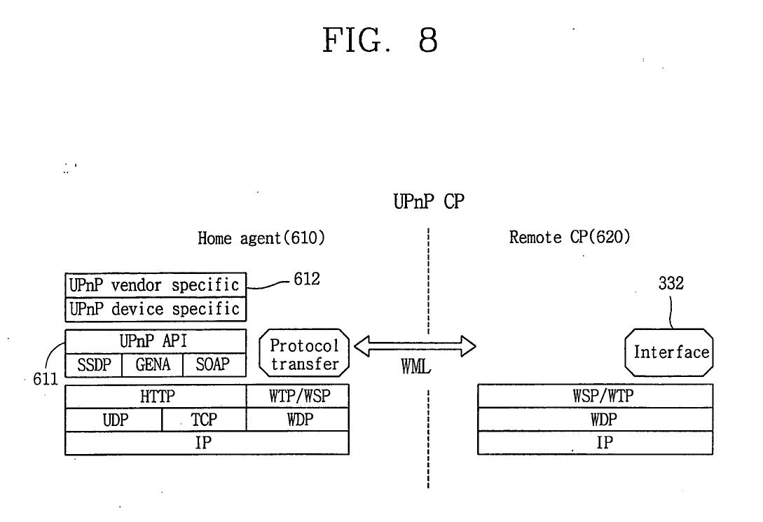

FIG. 8 is an exemplary view showing a case of distributing functions of a home agent 610 and a remote CP 620 so that the home agent 610 performs most of CP functions 611 and 612 and shows only an interface to the remote CP 620. That is, the home agent 610 generates its operation result in WML, provides the result to the remote CP 620 and receives a pertinent command In a WML form. In this case, the home agent 610 operates as a kind of a UPnP CP proxy.

As so far described, in order to make home network access from the outside possible, the present invention distributes a function of a UPnP CP to a remote CP in a mobile terminal and a home agent in a home network, Therefore a flexible correspondence to various UPnP devices and a remote terminal is possible, thereby the present invention can achieve the effects below.

First, an operation of a remote terminal can be optimized by differently corresponding an implementation method according to a performance degree of the remote terminal.

Second, the latest service can be provided on each UPnP device by dynamically downloading a specialized component to every certain UPnP device.

Third, a bandwidth of a wireless network can be stored by using a moderation function of an event message.

Fourth, a standard of an existing UPnP device architecture version 1.0 can be maintained by respectively setting the UPnP CP function at a home agent and at the remote CP, even though various ways of implementation are provided.

Accordingly, in the present invention, the UPnP CP function which follows the UPnP device architecture version 1.0 standard and supports various service controls without being restricted by various limitations of a radio mobile communication environment, can be implemented in a remote terminal (mobile terminal) positioned at a remote area. That is, a remote control method of a home network and its system according to the present invention can control devices connected to a home network system at a remote area by setting the UPnP CP provided to the UPnP-based home network system at a home agent in the UPnP home network system and at a remote control point of a remote terminal respectively.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A remote control method of a home network comprising:
setting a CP (Control Point) controlling devices connected to a home network system at a home agent in the home network system and at a remote CP of a remote terminal respectively; and
connecting the CP set at the home agent and the CP set at the remote CP through a specific channel.

2. The method of claim 1, wherein the home network system is based on a UPnP (Universal Plug and Play).

3. The method of claim 1, wherein the remote CP of the remote terminal controls devices through the home agent communicating with the devices connected to the home network system.

4. The method of claim 2, wherein, when the remote terminal has stacks of TCP/IP and HTTP, the home agent performs a function of a SSDP (Simple Service Discovery Protocol) and a GENA (Generic Event Notification Architecture) using an IP multicast, and the remote terminal performs functions of a series of a SOAP (Simple Object Access Protocol), a GENA and a user interface which include a UPnP API (Application Program Interface) function.

5. The method of claim 2, wherein, when the remote terminal has a WAP (Wireless Application Protocol) stack, the home agent performs a function of a SSDP and a GENA using an IP multicast and a WAP gateway function, and the remote terminal performs UPnP API, GENA* and SOAP* functions,
wherein the SOAP* and the GENA* are a SOAP and a GENA included in the WAP stack.

6. The method of claim 5, wherein the WAP gateway function is separated from the home agent.

7. The method of claim 5, wherein the WAP gateway function converts a SOAP* and a GENA* messages defined in WML (Wireless Markup Language) version into a SOAP and a GENA messages in an existing XML (Extensible Markup Language), and includes the converted messages in a HTTP.

8. A remote control system of a home network comprising:
a home network;
a home agent communicating with devices connected to the home network and having a function of a CP used at the home network; and
a remote CP set at a remote terminal and having a function of the CP,
wherein the CP of the home agent and the CP of the remote CP are connected through a specific channel.

9. The system of claim 8, wherein the home network is based on a UPnP (Universal Plug and Play).

10. The system of claim 8, further comprising a user interface unit set at the remote terminal and providing an interface to a user.

11. The system of claim 8, wherein the home agent includes a UPnP protocol processor for an IP multicast.

12. The system of claim 8, wherein, when the remote terminal has stacks of TCP/IP and HTTP, the home agent performs a function of a SSDP (Simple Service Discovery Protocol) and a GENA (Generic Event Notification Architecture) using an IP multicast, and the remote terminal performs functions of a series of the SOAP (Simple Object Access Protocol), the GENA and the user interface, which include a UPnP API (Application Program Interface) function.

13. The system of claim 8, wherein, when the remote terminal has a WAP (Wireless Application Protocol) stack, the home agent performs a function of a SSDP and a GENA using an IP multicast and a WAP gateway function, and the remote terminal performs UPnP API, GENA* and SOAP* functions,
wherein the SOAP* and the GENA* are a SOAP and a GENA included in the WAP stack.

14. The system of claim 13, wherein the WAP gateway function is separated from the home agent so as to exist at an external network.

15. The system of claim 13, wherein the WAP gateway function converts a SOAP* and a GENA* messages defined in WML (Wireless Markup Language) version into a SOAP and a GENA messages in a XML (Extensible Markup Language), and includes the converted messages in an HTTP.

16. A system for remotely controlling devices connected to a home network comprising:
a UPnP(Universal Plug and Play)-based home network;
a home agent communicating with devices in the home network and having a function of a UPnP CP (Control Point) used at the UPnP-based home network;
a remote CP set at the remote terminal and having a function of a UPnP CP; and
a user interface unit set at the remote terminal and providing an interface to a user,
wherein, the UPnP CP of the home agent and the UPnP CP of the remote CP are connected through a specific channel.

17. The system of claim 16, wherein, when the remote terminal has stacks of TCP/IP and HTTP, the home agent performs a function of a SSDP (Simple Service Discovery Protocol) and a GENA (Generic Event Notification Architecture) using an IP multicast, and the remote terminal performs functions of a series of the SOAP (Simple Object Access Protocol), the GENA and the user interface including a UPnP API (Application Program Interface) function.

18. The system of claim 16, wherein, when the remote terminal has a WAP (Wireless Application Protocol) stack, the home agent performs a function of a SSDP and a GENA using an IP multicast and a WAP gateway function, and the remote terminal performs UPnP API, GENA* and SOAP* functions,
wherein the SOAP* and the GENA* are a SOAP and a GENA included in the WAP stack.

19. The system of claim 18, the WAP gateway function is separated from the home agent.

20. The system of claim 18, the WAP gateway function converts a SOAP* and a GENA* messages defined in WML (Wireless Markup Language) version into a SOAP and a GENA messages in a XML (Extensible Markup Language), and includes the converted messages in a HTTP.

21. In a home network system performing a remote control by using a local CP, the local CP of the home network monitors whether a remote CP is enabled, and determines whether to transfer an authority for controlling UPnP devices on the basis of the monitoring result.

22. The local CP of claim 21, further comprising a step of obtaining state information from the remote CP.

23. The local CP of claim 22, further comprising a step of determining a range of an authority transfer on the basis of the received state information from the remote CP.

24. In a home network system performing a remote control by using a local CP, the local CP discovers devices connected in a local home network, stores information of the discovered devices, monitors whether a remote CP is connected to the local home network, and transmits the stored information to the remote CP on the basis of the monitoring result.

25. In a home network system performing a remote control by using a remote CP, the remote CP checks whether the remote CP can be connected to a local home network, connects itself to the home network on the basis of the check result, and transmits its state information when it is connected to the home network.

26. In a home network system performing a remote control by using a remote CP, the remote CP receives device information from a local CP and controls a device connected to the home network system on the basis of the received information.

27. The remote CP of claim 26, wherein the remote CP directly controls the device.

28. The remote CP of claim 26, wherein the remote CP controls the device through the local CP.
